(19) United States
(12) Patent Application Publication
(10) Pub. No.: US 2012/0279099 A1
(43) Pub. Date: Nov. 8, 2012

(54) ASSEMBLING FRAME FOR LICENSE PLATE

(76) Inventor: Stanley Kuo, Taipei (TW)

(21) Appl. No.: 13/099,659

(22) Filed: May 3, 2011

(51) Int. Cl. B60R 11/00; B60R 13/10

(52) U.S. Cl. 40/209

(57) ABSTRACT

This application discloses an assembling frame for license plate. The mentioned assembling frame for license plate comprises a first frame part, and a second frame part. A connecting part is employed for ensuring the assembling of the first frame part and the second frame part. When combining the assembling frame for license plate with a license plate, the license plate will be surrounded with the first frame part and the second frame part. According to this invention, a license plate can be decorated with the first frame part and the second frame part, and the identification of the containing of the license plate will not be affected by the assembling frame for license plate of this invention.

### BACKGROUND OF THE INVENTION

1. Field of the Invention

The present invention generally relates to a frame for license plate, especially to an assembling frame for license plate.

2. Description of the Prior Art

A license plate is an important identification for a vehicle. At first appearance, excluding the numbers/letters/words on a license plate for identifying, the regular license plates seem similarly to each other. In order to show something out of the ordinary and/or personal character on a license plate, many different ornaments for a license plate are presented.

For example, a license plate is added a frame with lighting, light-reflecting, or fluorescing effect. In another case, some fluorescing or light-reflecting effect is added onto the identifying numbers/letters/words of a license plate. Some commercial available decorating elements for license plate will make the containing of a license plate becoming difficult to be identified. Some criminals can use the mentioned decorating elements to hind the identification information of their license plate from the tracing of the police. So that, in many countries, it is illegal for a driver to “modify” the license plate with any decorating elements that can affect the identification of the containing of the license plate.

Therefore, it is desirable to provide a decoration of a license plate being out of the ordinary, and not affecting the identification of the containing of the license plate.

### SUMMARY OF THE INVENTION

According to the above, the present invention provides an assembling frame for license plate.

It is one object of the present invention to provide an assembling frame for license plate, wherein the assembling frame for license plate can be disassembled for saving space when not being used.

It is another object of the present invention to provide an assembling frame for license plate with two assemble-able pieces, so that the assemble-able pieces can be assembled in many different ways for presenting individual styles.

It is still another object of the present invention to provide an assembling frame for license plate with a connecting part, so that the assembling frame for license plate can be easily and rapidly assembled/disassembled through the connecting part.

It is still another object of the present invention to provide an assembling frame for license plate with an auxiliary fastening part for assisting the combination of the assembling frame and the license plate.

Accordingly, the present invention discloses an assembling frame for license plate, comprises a first frame part, and a second frame part. The first frame part and the second frame part can be assembled and secured through a connecting part. After assembling, the assembling frame according to this invention can be employed to surround and decorate a license plate, and the assembling frame will not affect the identification of the containing of the license plate.

### BRIEF DESCRIPTION OF THE DRAWINGS

The present disclosure can be described by the embodiments given below. It is understood, however, that the embodiments below are not necessarily limitations to the present disclosure, but are used to a typical implementation of the invention.

FIG. 1 shows one preferred example of an assembling frame for a license plate;

FIG. 2A shows one preferred example of a connecting part of an assembling frame for a license plate according to this invention;

FIG. 2B shows another preferred example of a connecting part of an assembling frame for a license plate according to this invention;

FIG. 2C shows still another preferred example of a connecting part of an assembling frame for a license plate according to this invention;

FIG. 3 shows one preferred example of an auxiliary fastening part of an assembling frame for a license plate according to this invention;

FIG. 4A shows a front view of one preferred example of an assembling frame of this invention combined with a license plate; and

FIG. 4B shows a rear view of one preferred example of an assembling frame of this invention combined with a license plate.

### DESCRIPTION OF THE PREFERRED EMBODIMENTS

What probed into the invention is an assembling frame for license plate. Detailed descriptions of the structure and elements will be provided in the following in order to make the invention thoroughly understood. Obviously, the application of the invention is not confined to specific details familiar to those who are skilled in the art. On the other hand, the common structures and elements that are known to everyone are not described in details to avoid unnecessary limits of the invention. Some preferred embodiments of the present invention will now be described in greater details in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

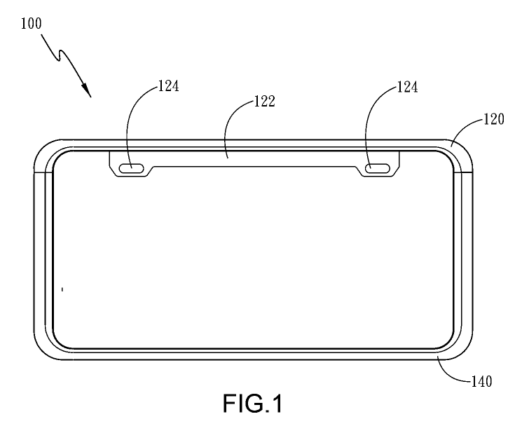

One preferred embodiment according to this specification discloses an assembling frame for license plate. FIG. 1 is one preferred example of an assembling frame for license plate according to this embodiment. As shown in FIG. 1, the assembling frame 100 comprises a first frame part 120, and a second frame part 140. In one preferred example according to this embodiment, the first frame part 120 and the second frame part 140 are individually formed in U-shaped. After assembling, the first frame part 120 and the second frame part 140 can be employed to surround the edge of a license plate, and the first frame part 120 and the second frame part 140 will not affect the identification of the containing of the license plate. The composition of the first frame part 120 and the second frame part 140 can be selected from one of the following: wood, plastic, rubber, polymer, and the mixture thereof.

Referred to FIG. 1, the first frame part 120 comprises a fastening portion 122, and two license plate fastening holes 124. The mentioned fastening portion 122 is positioned at one rim of the first frame part 120. In one preferred example of this embodiment, the fastening portion 122 is extended from the first frame part 120. The license plate fastening holes 124 are positioned at the fastening portion 122. According to this embodiment, the first frame part 120 can be combined with a license plate by two fastening elements, not shown in FIG. 1, individually passing through the corresponding fastening holes on the license plate and the license plate fastening holes 124.

According to this embodiment, those two end portions of the second frame part 140 can be individually assembled with those two corresponding end portions of the first frame part 120 through a connecting part, not shown in FIG. 1. The connecting part is employed to ensure the assembling status of each pair of end portions of the first frame part 120 and the second frame part 140.

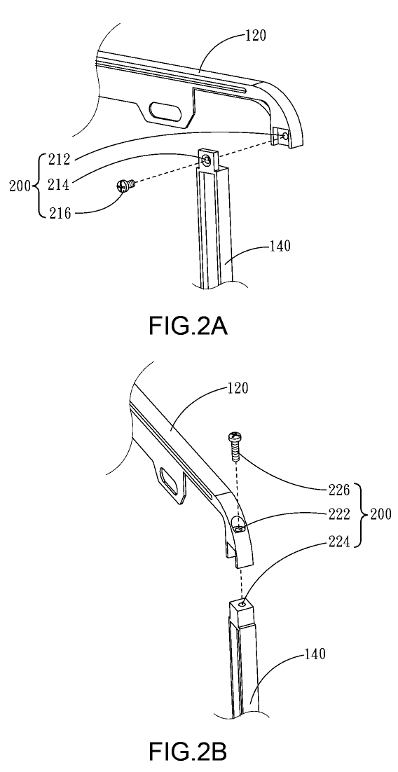

As shown in FIG. 2A, in one preferred example of this embodiment, the connecting part 200 comprises two first assembling holes 212, two second assembling holes 214, and two assembling elements 216. FIG. 2A presents a partial magnification of an assembling frame for license plate of one preferred example according to this embodiment. FIG. 2A shows one end of the first frame part 120, one end of the second frame part 140, and the connecting part 200 according to this embodiment. According to this preferred example, the connecting part at the other ends of the first frame part 120 and the second frame part 140 can be the same as the connecting part shown in FIG. 2A. The mentioned first assembling holes 212 can be individually positioned at the two ends of the first frame part 120. The mentioned second assembling holes 214 can be individually positioned at the two ends of the second frame part 140. Referred to FIG. 2A, each of the assembling elements 216 passes through one of the first assembling holes 212 and the corresponding second assembling hole 214 for fastening the assembled ends of the first frame part 120 and the second frame part 140 in the direction perpendicular to the assembling direction of the first frame part 120 and the second frame part 140. Preferably, as shown in FIG. 2A, the first assembling hole 212 can be positioned at a concave portion at the end of the first frame part 120. So that, the assembling frame according to this example can perform a smooth outward appearance, and the assembling element 216 can efficiently fasten the first frame part 120 and the second frame part 140. In one preferred performance of this example, the assembling element 216 is employed to fasten the ends of the first frame part 120 and the second frame part 140 through screwing. That is, the assembling elements can be screws.

As shown in FIG. 2B, in another preferred example of this embodiment, the connecting part 200 comprises two first assembling holes 222, two second assembling holes 224, and two assembling elements 226. FIG. 2B presents a partial magnification of an assembling frame for license plate of another preferred example according to this embodiment. FIG. 2B shows one end of the first frame part 120, one end of the second frame part 140, and the connecting part 200 according to this embodiment. According to this preferred example, the connecting part at the other ends of the first frame part 120 and the second frame part 140 can be the same as the connecting part shown in FIG. 2B. The mentioned first assembling holes 222 can be individually positioned at the two ends of the first frame part 120. The mentioned second assembling holes 224 can be individually positioned at the two ends of the second frame part 140. Referred to FIG. 2B, each of the assembling elements 226 passes through one of the first assembling holes 222 and the corresponding second assembling hole 224 for fastening the assembled ends of the first frame part 120 and the second frame part 140 in the direction parallel to the assembling direction of the first frame part 120 and the second frame part 140. Preferably, as shown in FIG. 2B, the first assembling hole 222 can be positioned at a concave portion at the end of the first frame part 120. So that, the assembling frame according to this example can perform a smooth outward appearance, and the assembling element 226 can efficiently fasten the first frame part 120 and the second frame part 140. In one preferred performance of this example, the assembling element 226 is employed to fasten the ends of the first frame part 120 and the second frame part 140 through screwing. In other words, the assembling elements can be screws.

As shown in FIG. 2C, in still another preferred example of this embodiment, the connecting part 200 comprises two assembling holes 232, and two assembling elements 234. FIG. 2C presents a partial magnification of an assembling frame for license plate of still another preferred example according to this embodiment. FIG. 2C shows one end of the first frame part 120, one end of the second frame part 140, and the connecting part 200 according to this embodiment. According to this preferred example, the connecting part at the other ends of the first frame part 120 and the second frame part 140 can be the same as the connecting part shown in FIG. 2C. The mentioned assembling holes 232 can be individually positioned at those two ends of the first frame part 120. The mentioned assembling elements 234 can be individually positioned at the two ends of the second frame part 140. Referred to FIG. 2C, when assembling the first frame part 120 and the second frame part 140, the assembling elements 234 will embed in the corresponding assembling holes 232 for fastening the assembled ends of the first frame part 120 and the second frame part 140. In one preferred performance of this example, each of the assembling elements is elastic, and with a hook-like portion. Referred to FIG. 2C, when the assembling element 234 sliding into the first frame part 120, the hook-like portion of the elastic assembling element will embed in the assembling hole 232.

In still another preferred example of this embodiment, the mentioned connecting part 200 comprises two assembling holes, and two assembling elements. The mentioned assembling holes can be individually positioned at those two ends of the second frame part 140. The mentioned assembling elements can be individually positioned at those two ends of the first frame part 120. When assembling the first frame part 120 and the second frame part 140, the assembling elements will individually embed into the corresponding assembling holes for fastening and ensuring the assembled ends of the first frame part 120 and the second frame part 140. This example is similar to the above example excluding that the positions of the assembling holes and the assembling elements of this example are opposite to the above example in FIG. 2C. So, when reading in this example, FIG. 2C can still be referred.

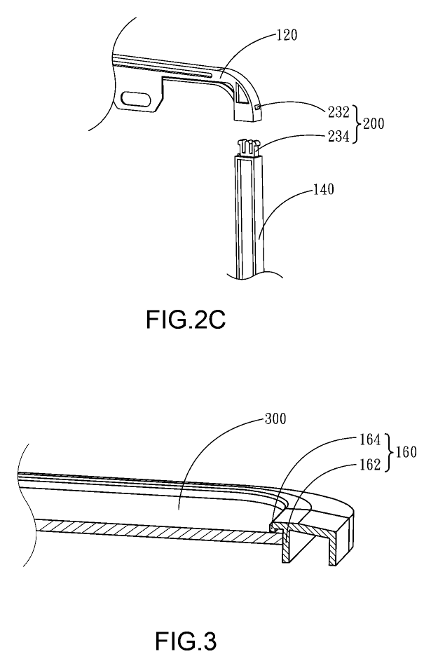

According to this embodiment, the first frame part 120 and the second frame part further comprises an auxiliary fastening part. FIG. 3 shows a partial magnification of an assembling frame for license plate according to this embodiment. Referred to FIG. 3, the auxiliary fastening part 160 comprises a first auxiliary fastening portion 162, and a second auxiliary fastening portion 164. When the assembling frame of this embodiment combining with a license plate 300, the edge of the license plate 300 will against the first auxiliary fastening portion 162, and the second auxiliary fastening portion 164 can against the front side of the license plate 300, as shown in FIG. 3. In one preferred example of this embodiment, the auxiliary fastening part 160 is J-shaped.

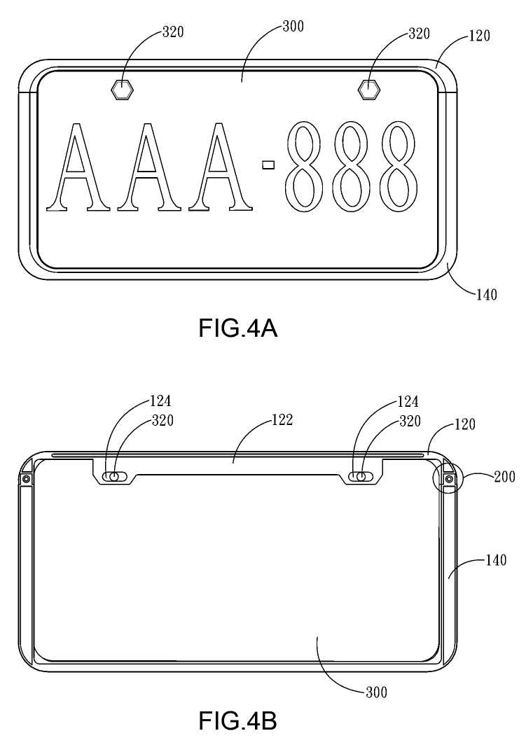

FIG. 4A and FIG. 4B present a front view and a rear view of an assembling frame according to this invention combining with a license plate. As shown in FIG. 4A, after combining the assembling frame and the license plate with license plate fastening elements 320, the license plate 300 is surrounded by the assembling frame with the first frame part 120 and the second frame part 140. According to this invention, the auxiliary fastening part, not shown in the figure, of the assembling frame will assist in fastening the license plate 300, and cover some edge portion of the license plate 300. Referred to FIG. 4A, the containing of the license plate 300 will not be covered by the auxiliary fastening part. According to this invention, an end user can select the first frame part 120 and the second frame part 140 with the same color or style to decorate the license plate 300. In another case, an end user can select the first frame part 120 and the second frame part 140 with different color or style to decorate the license plate 300.

As shown in FIG. 4B, from the rear view, it is clear to find out the assembling between the first frame part 120 and the second frame part 140 through the connecting part 200, and the combining between the license plate 300 and the fastening portion 122 through the license plate fastening elements 320.

To sum up, this present application discloses an assembling frame for license plate. The assembling frame for license plate comprises a first frame part, and a second frame part. After assembling the first frame part and the second frame part, the assembling frame can be combined with a license plate. When combining the assembling frame for license plate of this invention with a license plate, the license plate will be surrounded by the first frame part and the second frame part. The first frame part and the second frame part can be employed for decorating a license plate. The assembling between the first frame part and the second frame part can be ensured through a connecting part. The assembling frame for license plate can further comprise an auxiliary fastening part positioned at the inside of the first frame part and the second frame part. When the assembling frame for license plate according to this invention combining with a license plate, the edge of the license plate will against the first auxiliary fastening portion of the auxiliary fastening part, and the second auxiliary fastening portion of the auxiliary fastening part can against the front side of the license plate. According to this invention, a license plate can be decorated though the first frame part and the second frame part of this invention. Preferably, the assembling frame for license plate of this invention will not affect the identification of the containing of the license plate.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. An assembling frame for license plate, comprising:
a first frame part, wherein the first frame part is U-shaped, wherein the first frame part comprises a rim of the first frame part, the license plate fastening holes are positioned at the fastening portion, wherein the first frame part is combined with a license plate through employing two license plate fastening elements individually pass through two corresponding fastening holes of the license plate and the license plate fastening holes of the first frame part; and
a second frame part, wherein the second frame part is U-shaped, wherein those two ends of the second frame part are assembling with those corresponding two ends of the first frame part through a connecting part;
wherein the first frame part and the second frame part further comprises an auxiliary fastening part positioned at the inside of the first frame part and the second frame part, wherein the auxiliary fastening part comprises a first auxiliary fastening portion and a second auxiliary fastening portion, when combining the license plate with the first frame part and the second frame part, the edge of the license plate is against the first auxiliary portion, and the second auxiliary portion is against the front side of the license plate.

2. The assembling frame for license plate according to claim 1, wherein the connecting part comprises two first assembling holes, two second assembling holes, and two assembling elements, wherein the first assembling holes are individually positioned at the two ends of the first frame part, wherein the second assembling holes are individually positioned at the two ends of the second frame part, wherein each of the assembling elements passes through one of the first assembling holes and the corresponding second assembling hole to ensure the assembled ends of the first frame part and the second frame part in the direction perpendicular to the assembling direction of the first frame part and the second frame part.

3. The assembling frame for license plate according to claim 2, wherein the assembling elements are screws.

4. The assembling frame for license plate according to claim 1, wherein the connecting part comprises two first assembling holes, two second assembling holes, and two assembling elements, wherein the first assembling holes are individually positioned at those two ends of the first frame part, wherein the second assembling holes are individually positioned at those two ends of the second frame part, wherein each of the assembling elements passes through one of the first assembling holes and the corresponding second assembling hole to ensure the assembled ends of the first frame part and the second frame part in the direction parallel to the assembling direction of the first frame part and the second frame part.

5. The assembling frame for license plate according to claim 4, wherein the assembling elements are screws.

6. The assembling frame for license plate according to claim 1, wherein the connecting part comprises two assembling holes and two assembling elements, wherein the assembling holes are individually positioned at those two ends of the first frame part, wherein the assembling elements are individually positioned at those two ends of the second frame part, when assembling the first frame part and the second frame part, each of the assembling elements embeds in the corresponding assembling hole for fastening the assembled ends of the first frame part and the second frame part.

7. The assembling frame for license plate according to claim 6, wherein each of the assembling elements is elastic and with a hook-like portion.

8. The assembling frame for license plate according to claim 1, wherein the connecting part comprises two assembling holes and two assembling elements, wherein the assembling elements are individually positioned at those two ends of the first frame part, wherein the assembling holes are individually positioned at those two ends of the second frame part, when assembling the first frame part and the second frame part, each of the assembling elements embeds in the corresponding assembling hole for fastening the assembled ends of the first frame part and the second frame part.

9. The assembling frame for license plate according to claim 8, wherein each of the assembling elements is elastic and with a hook-like portion.

10. The assembling frame for license plate according to claim 1, wherein the composition of the first frame part and the second frame part is selected from one of the following: wood, plastic, rubber, polymer.
